(19) United States
(12) Patent Application Publication
(10) Pub. No.: US 2011/0017130 A1
(43) Pub. Date: Jan. 27, 2011

(54) DEVICE FOR PASTILLIZING

(75) Inventors: Hans-Kuert Schromm, Backnang (DE); Konrad Schermutzki, Remseck (DE); Matthias Kleinhans, Waiblingen (DE)

Correspondence Address: DRINKER BIDDLE & REATH (DC), 1500 K STREET, N.W., SUITE 1100, WASHINGTON, DC, 20005-1209, US

(73) Assignee: Sandvik Materials Technology Deutschland GmbH, Dusseldorf (DE)

(21) Appl. No.: 12/867,299

(22) PCT Filed: Feb. 4, 2009
(86) PCT No.: PCT/EP09/00726

§ 371 Date: Oct. 12, 2010

(30) Foreign Application Priority Data
Feb. 13, 2008 (DE) 10 2008 010 351.9

(51) Int. Cl. B05C 5/02

(52) U.S. Cl. 118/300; 222/420

(57) ABSTRACT

A device for expelling drops of a flowable product. The invention relates to a device for expelling drops of a flowable product, comprising a rotating outer drum and a feed channel for the product to be expelled extending into the outer drum, wherein the outer drum comprises passage openings on the circumference thereof, through which the product to be expelled runs from the feed channel and then exits in droplet shape. According to the invention, at least one outer circumference of the outer drum is provided with a coating that reduces wetting with the product to be tabletted compared to a base material of the outer drum. For example, the invention can be used for tabletting flowable products.

The invention relates to a device for expelling drops of a flowable product having a rotating outer drum and a feed channel extending into the outer drum for the product to be expelled, where the outer drum has on its circumference passage openings through which the product to be expelled runs from the feed channel and then exits in droplet shape.

Such devices for pastillizing are known and described for example in the European laid-open publication EP 0 145 839 A2. Such devices are manufactured and marketed by the applicant under the trade name of “Rotoform”.

The invention is intended to create an improved device for expelling drops.

In accordance with the invention, a device for expelling drops of a flow-able product having a rotating outer drum and a feed channel extending into the outer drum for the product to be expelled is provided for that purpose, where the outer drum has on its circumference passage openings through which the product to be expelled runs from the feed channel and then exits in droplet shape, where at least one outer circumference of the outer drum is provided with a coating which reduces wetting with the product to be expelled when compared with a basic material of the outer drum.

Surprisingly, it has become evident that the reduction of wetting at least on the outer circumference of the outer drum improves the quality of the manufactured pastilles or solidified product droplets. In fact the droplets created by the perforated outer drum are deposited on the steel belt or transferred to a drop section better and without residues thanks to the coating, which reduces wetting with the product to be expelled. In particular it can be observed that the pastilles are deposited more evenly and in a more controlled way on the belt since the droplets come away from the outer drum faster and without leaving residues on the latter. As a result, the steel belt can be covered more densely with droplets, so that an increase in the pastillizing capacity can be achieved in general, and in particular with the same facility size. A thickness of the coating is preferably less than 1 mm. Good results are achieved with coatings whose thickness is between 0.001 mm (10⁻⁶ m) and 0.1 mm (100×10⁻⁶ m). Furthermore, the coating, provided at least on the outer circumference of the outer drum, prevents the creation of secondary droplets, which takes place in conventional devices because product residues remain on the rotating outer drum and are then thrown clear of the latter and consequently land as small droplets in uncontrolled manner on the steel belt. The creation of secondary droplets on the steel belt is prevented by the coating in accordance with the invention. Since no product residues remain on the outside of the perforated outer drum, a so-called guide, with which product residues are usually forced off the outer circumference of the outer drum and back into the passage openings of the outer drum and by which at the same time the outer circumference of the outer drum is cleaned, can be dispensed with. The device in accordance with the invention is suitable for expelling drops of liquid or pasty substances, for example product melts, and in particular also for substances that can already be tabletted with the known Rotoform devices of the applicant. The perforated outer drum can be arranged above a continuous steel belt, above the drop section of a prilling tower or above a solidifying channel.

In an embodiment of the invention, the inner walls of the passage openings are at least partially provided with the coating.

Droplet formation can be further improved as a result. Advantageously, the inner walls of the passage openings are only partially coated and in particular only the exit area, i.e. that area immediately adjoining the outer circumference, is provided with the coating. For example, starting from the outer circumference only about a quarter to a third of the length of the passage opening can be provided with the coating. Even a partial coating of this type, applicable in simple manner starting from the outer circumference of the drum, has an extremely positive effect on the expelling of drops.

In an embodiment of the invention, the coating forms with the product to be expelled a contact angle of more than 90°, in particular more than 120°.

In this way, the adhesion of product residues is substantially completely prevented. With a contact angle of more than 90°, noteworthy wetting no longer occurs, since a product droplet contracts on the coated surface to an almost spherical droplet. With a slight inclination of the surface, the droplet slides down without any residues, i.e. the flowable product rolls off. In the ideal case, a contact angle of 180° is achieved, such that in this case the product droplet contacts the coated surface only at one point. In the special case where water is the liquid, the surface is hydrophobic at angles of more than 90°, while at a contact angle of more than 120° a surface is referred to as super-hydrophobic. When the contact angles are even larger, a so-called lotus effect is the result.

In an embodiment of the invention, the coating is designed as a nano-coating, in particular as a super-hydrophobic nano-coating.

With a nano-coating, wetting with the product to be tabletted can be extremely reduced and practically completely prevented, so that the adhesion of product droplets to the outer circumference is completely prevented. The product droplets thus come away easily and in controlled manner from the outer drum and can as a result be deposited more closely next to one another on the steel belt in comparison with conventional devices, and a guide on the outer drum can be dispensed with. In the case when a flowable product containing water is to be tabletted, a super-hydrophobic nano-coating is provided. A nano-coating refers to a coating having a nano-structured surface with elevations and depressions in the range of less than 100 nm. Thanks to this surface structure, a wetted surface is reduced also because of the geometrical ratios. A deposited nano-coating can be further improved if it is deposited onto a micro-structured surface that forms elevations and depressions in the range of less than 15 micrometers. At least the outer circumference and if necessary the inner walls of the passage openings are therefore advantageously provided with a micro-structured surface onto which a coating is applied which forms a nano-structured surface.

In an embodiment of the invention the coating consists of plastic.

Plastic coatings can be dependably applied to numerous materials, for example onto an outer drum of stainless steel, and have good properties with regard to the reduction of wetting and to the service life of the coating. For example, the plastic coating can have silicone, polytetrafluoro-ethylene (PTFE), perfluoro-alkoxyalkane (PFA), polyether ether ketone, polypropylene, polyamide or polyethylene.

The coating can however for example also be a ceramic coating or comprise a nano-paint. Nano-paints are paints that can be applied to the outer drum and then form a coating which extremely reduces wetting.

In an embodiment of the invention, the coating comprises a flowable medium, in particular oil, grease, water-diluted media such as detergents, emulsions, polyether-modified polysiloxanes and/or wax. A coating that reduces wetting can also be achieved by means of a flowable medium. Good results are obtained in particular for water-containing products to be tabletted with coatings of oil, grease and/or wax.

In an embodiment of the invention, means are provided to spray on and/or apply the coating continuously or at predefined intervals.

In the case of coatings comprising flowable media in particular, these coatings are worn down comparatively quickly and the renewal of these coatings at predefined intervals or continuously may be necessary. For applying the coatings, spray nozzles or applicator rolls can for example be used. The outer circumference and the inner walls of the passage openings can for example be continuously recoated by means of spray nozzles. Alternatively, a spray nozzle or applicator roll can be used to apply so much flowable medium to the outer circumference that this medium flows into the passage openings under its own weight when the appropriate passage opening is positioned just in the upper area of the outer circumference.

In an embodiment of the invention, the product to be expelled and the coating have an opposite polarity.

In particular when a coating is a flowable medium and during expelling of drops of liquids, in particular melts, it must be ensured that the product to be expelled is not soluble into this flowable coating medium. Polar materials dissolve well in polar solvents and nonpolar materials dissolve well in nonpolar solvents. When the polarity is opposite, the product to be expelled and the coating are thus poorly soluble, When pastillizing polar materials, therefore, a nonpolar coating can be used with good results.

Further features and advantages of the invention can be gathered from the claims and the following description of preferred embodiments of the invention in conjunction with the drawings. Individual features of the various embodiments shown can be combined with one another as required without going beyond the scope of the application. The drawings show in

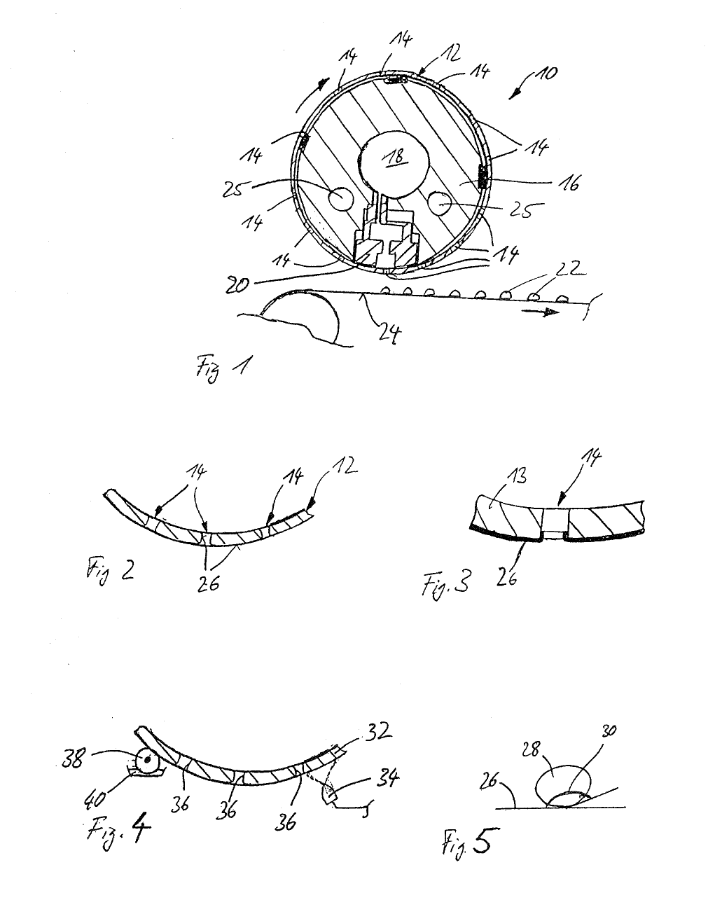

FIG. 1 a schematic sectional view of a device in accordance with the invention for pastillizing of flowable products,

FIG. 2 a sectional view of a section of the outer drum of the device in FIG. 1,

FIG. 3 a sectional view of a section of an outer drum of a further embodiment of the invention,

FIG. 4 a sectional view of a section of the outer drum of another embodiment of the invention, and

FIG. 5 a schematic view of a product droplet on a coated surface.

The schematic sectional view in FIG. 1 shows a device 10 for pastillizing of flowable products. The device 10 has a rotating outer drum 12 provided with passage openings 14 spread over its circumference. The rotating outer drum 12 is arranged rotatably on a cylindrical core 16 inside which are provided a feed channel 18 for a product to be tabletted and a nozzle bar 20 adjoining an inner circumference of the outer drum 12. Flowable product to be tabletted is conveyed via the feed channel 18 into the nozzle bar 20 and thus contacts the inside of the outer drum 12. As soon as one of the passage openings 14 passes underneath the nozzle bar 20, the flowable product is forced through the passage opening 14 or flows by itself through it. After leaving the passage opening 14 a product droplet 22 forms which is then deposited onto a continuous steel belt 24. The steel belt 24 is for example cooled, so that the product droplets 22 solidify during transportation on the steel belt 24 and can then be removed from the steel belt 24 and further processed at a deflection point, not shown in FIG. 1. Heating channels heat the core 16 and thereby keep the product in a flowable state.

In the enlarged sectional view in FIG. 2, a section of the outer drum 12 is shown. The outer circumference of the outer drum 12 and the inner walls of the passage openings 14 inside outer drum 12 are provided with a coating 26. The coating 26 reduces wetting by the product to be tabletted when compared with a basic material of the outer drum 12, for example stainless steel. The coating 26 here forms with the product to be tabletted a contact angle of more than 90°. This ensures that no product residues remain inside the passage openings 14 or on the outer circumference after the product droplets 22 have been deposited on the steel belt 24. The product droplets 22 slide, after the rear of the passage openings 14 has been closed again by the nozzle bar 20, easily and without leaving residues out of the passage openings 14 and come away quickly and without leaving residues from the coating 26 on the outer circumference of the outer drum 12. The crucial factor here is that the outer circumference is provided with the coating 26. A coating of the inner walls of the passage openings 14 can be advantageous, but is not essential. The invention can be used for expelling drops of many products which for example can be processed by the known Rotoform devices. The creation of so-called secondary droplets, i.e. product residues thrown in uncontrolled manner from the outer drum 12 during rotation onto the steel belt 24, can as a result be substantially completely prevented. Since the product droplets 22 slide in a quicker and more controlled manner out of the passage openings 14 onto the steel belt 24 and come away more rapidly from the outer circumference, the product droplets 22 can be deposited more closely to one another compared to conventional devices. This leads to an increased capacity of the pastillizing facility. Since secondary droplets are prevented, an improved tablet quality is also achieved.

The device 10 itself can furthermore be simplified since a guide, usually necessary in conventional devices to force product residues from the outer circumference of the outer drum back into the passage openings 14 and to clean the outer circumference of the outer drum 12, can be dispensed with.

The illustration in FIG. 3 shows an enlarged sectional view of a section of an outer drum 13 in accordance with a further embodiment of the invention. It can be discerned that the coating 26 is only applied to a partial area of the inner wall of the passage opening 14. In particular the coating 26 covers the complete outer circumference of the outer drum 13, but extends from the outer circumference only over about one quarter of the length of the passage opening 14 into the latter. The rim at the transition between the inner wall 14 and the outer circumference of the outer drum 13 is thus completely covered by the coating. The rear section, when viewed from the outer circumference, of the inner wall of the passage opening 14 remains by contrast uncoated. A coating 26 of this type can be applied in simple manner from the outer circumference and ensures a considerably improved detachment behaviour of the product droplets from the outer circumference.

The illustration in FIG. 5 shows in schematic form a product droplet 28 contacting a flat surface provided with the coating 26. It can be discerned that the product droplet 28 has contracted to approximately spherical form. A contact angle 30 is now measured between the coating 26 and the surface of the product droplet 28. In the case shown, the contact angle 30 is considerably higher than 90° and about 160°. With these very high contact angles, an extremely low wettability and the so-called lotus effect are achieved.

If a surface tension of the product droplet 28 is reduced, the droplet 28 comes apart and the contact angle 30 decreases, in the extreme case to values close to 0°.

The illustration in FIG. 4 shows a further sectional view of a section of an outer drum 32 of a device for pastillizing in accordance with the invention. The outer drum 32 is designed identical to the outer drum 12 in FIG. 1, but the pastillizing device has opposite the outer circumference of the outer drum 32 spray nozzles 34 with which a liquid medium, for example oil, is sprayed onto the outer circumference of the outer drum 32. The spray nozzles 34 are arranged underneath the outer drum 32, but can be arranged substantially at any point on the outer circumference. The sprayed-on oil reaches first the outer circumference of the outer drum 32, and then, in the upper section of the outer circumference, not shown, possibly by weight also the inner walls of the passage openings 36 in the outer drum 32. An oil film thus forms on the outer circumference of the outer drum 32 and possibly on the inner walls of the passage openings 36, and considerably reduces the wetting of a for example water-containing product to be tabletted.

Alternatively or additionally to spraying on of a coating using a liquid medium, the illustration in FIG. 4 shows an applicator roll 38 contacting the outer circumference of the outer drum 32. The applicator roll 38 is wetted on its outer circumference inside a trough 40 forming a liquid reservoir and then transfers the liquid on its outer circumference onto the outer circumference of the outer drum 32. The coating applied by the applicator roll 38 then forms with the product to be tabletted a very low contact angle and thereby reduces wetting.

1. Device for expelling drops of a flowable product having a rotating outer drum and a feed channel extending into the outer drum for the product to be expelled, where the outer drum has on its circumference passage openings through which the product to be expelled runs from the feed channel and then exits in droplet shape, wherein at least the outer circumference of the outer drum is provided with a coating which reduces wetting with the product to be expelled when compared with a basic material of the outer drum.

2. Device according to claim 1, wherein the inner walls of the passage openings are at least partially provided with the coating.

3. Device according to claim 1, wherein the coating forms with the product to be expelled a contact angle of more than 90°.

4. Device according to claim 1, wherein the coating is designed as a nano-coating.

5. Device according to claim 1, wherein the coating consists of plastic.

6. Device according to claim 1, wherein the coating has silicone, polytetrafluorethylene (PTFE), perfluoro-alkoxyalkane (PFA), polyether ether ketone (PEEK), polypropylene (PP), polyethylene (PE), polyamide (PA), nano-paint or ceramic.

7. Device according to claim 1, wherein the coating comprises a flowable medium.

8. Device according to claim 1, wherein means are provided to spray on and/or apply the coating continuously or at predefined intervals.

9. Device according to claim 1, wherein the product to be expelled and the coating have an opposite polarity.

10. Device according to claim 3, wherein the contact angle is more than 120°.

11. Device according to claim 7, wherein the flowable medium is oil, grease, or a water-diluted media.

12. Device according to claim 11, wherein the water-diluted media is a detergent, an emulsion, a polyether-modified polysiloxanes or a wax.
